(19) United States
(12) Patent Application Publication
(10) Pub. No.: US 2014/0011492 A1
(43) Pub. Date: Jan. 9, 2014

(54) OPERATOR PREFERENCES FOR PACKET SWITCHED SERVICES ON LTE

(71) Applicant: Murali Bhaskara Rao Bharadwaj, San Diego, CA (US)

(72) Inventor: Murali Bhaskara Rao Bharadwaj, San Diego, CA (US)

(73) Assignee: QUALCOMM Incorporated, San Diego, CA (US)

(21) Appl. No.: 13/541,990

(22) Filed: Jul. 5, 2012

(51) Int. Cl. H04W 4/00

(52) U.S. Cl. 455/422.1

(57) ABSTRACT

A method, an apparatus, and a computer program product for wireless communication are provided in which a mobile station determines characteristics defining packet switched services available on a network. The mobile station may determine preferences, policies and permissions of a network operator, relating to selection of services used to make a voice, video or other call. The mobile station registers with an IP multimedia subsystem server, and the mobile station may then announce its presence using a presence server of its home network. The mobile station may establish calls through an address book that identifies other mobile stations that have announced presence on the presence server or on another presence server in communication with the home network presence server. When no presence server is available, mobile stations may exchange information using session initiation protocol (SIP) options to determine mutual capabilities and to initiate connections.

### BACKGROUND

1. Field

The present disclosure relates generally to communication systems, and more particularly, to call establishment in a wireless data network.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a mobile station or other user equipment (UE) determines characteristics of a network when a connection to the network is established. The characteristics may define packet switched (PS) services available on the network, including voice, video and file sharing services. In an LTE network, for example, the mobile station may determine if voice over LTE (VoLTE) is available. VoLTE may be a preferred method of providing voice connections in an LTE network. The mobile station may determine preferences, policies and/or permissions of an operator of the network which relate to selection between VoLTE and circuit-switched (CS) services. A carrier may provide simultaneous voice on LTE (SVLTE) using multiple antennas, while the operator prefers that voice connections be made using a CS connection.

In an aspect of the disclosure, the mobile station may register with an IP multimedia subsystem (IMS) server for one or more of voice, video telephony, and rich communication suite (RCS) services such as instant messaging and file sharing. Having registered with the IMS server, the mobile station may then announce its presence using a presence server of its home network. The mobile station may establish calls automatically (dialed calls) or through an address book that identifies other mobile stations that have announced presence on the presence server or on another presence server in communication with the home network presence server. When no presence server is available, mobile stations may exchange information using session initiation protocol (SIP) options to determine mutual capabilities and to initiate connections.

In an aspect of the disclosure, a UE may determine whether a wireless data network supports a voice service. The UE may register with an IMS server for the voice service when the wireless data network supports the voice service, and when an operator of the wireless data network permits use of the voice service.

In an aspect of the disclosure, the UE determines whether a user is available to receive a voice call using the voice service based on presence information of the user. A voice over data connection may be established with the user when the user is determined to be available to receive the voice call using the voice service. A CS voice connection may be established when the user is determined to be unavailable to receive the voice call using the voice service.

In an aspect of the disclosure, the wireless data network comprises a WiFi network and the voice service comprises voice over IP (VoIP). The wireless data network may comprise a high speed packet access (HSPA) network. The wireless data network comprises an LTE network and the voice service may comprise VoLTE.

In an aspect of the disclosure, confirmation of registration is received from the IMS server and, upon receipt or thereafter, the UE may announce presence on a presence server, which is configured to maintain presence information of the user. The presence information of the user may be maintained by a plurality of communicatively coupled presence servers. The presence information may include a current status of the user. Availability of a target user to receive the voice call may be identified in an address book maintained by one of the plurality of presence servers. Availability of the user may be determined from the presence information whether the user has access to a voice over data service.

In an aspect of the disclosure, the UE registers at the IMS server for a video telephony service and initiating a voice over data connection includes initiating a video telephony call when the presence information of the user indicates that the user is capable of receiving video telephony calls.

In an aspect of the disclosure, the UE registers at the IMS server for a rich communication suite (RCS) service. The RCS service may include one or more of instant messaging and a file sharing service.

In an aspect of the disclosure, a target user is determined to be available to receive the voice call using the voice service by exchanging SIP options with the target user. A voice over data connection with the user may be established based on capabilities of the user identified in the SIP options. The voice over data connection with the user may be established over one or more of an IP network, an HSPA network and an LTE network identified in the SIP options. A CS voice connection may be established with the target user based on capabilities of the user identified in the SIP options.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram illustrating a wireless networking environment.

FIG. 8 is a diagram illustrating interoperation of equipment in a wireless network.

FIG. 9 is a flow chart of a method of wireless communication.

FIG. 10 is a conceptual data flow diagram illustrating the data flow between different modules/means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

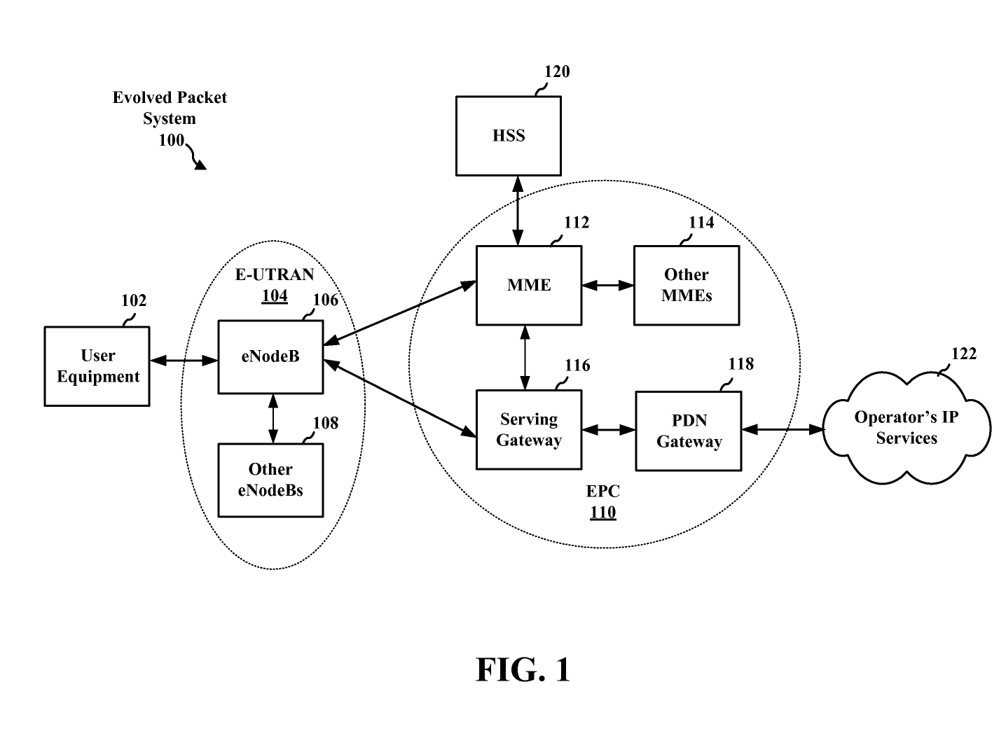

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

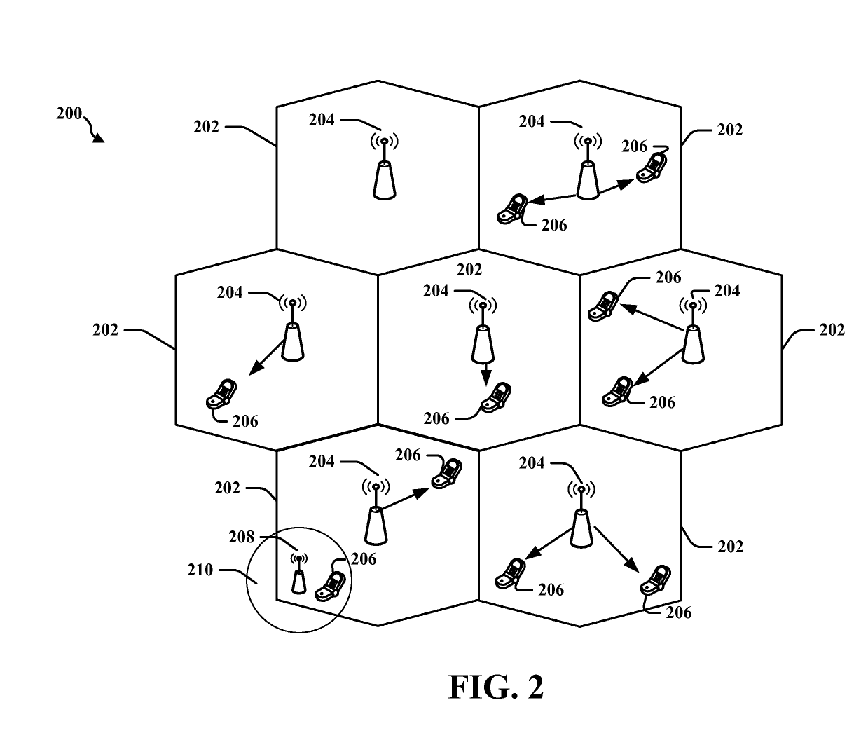

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

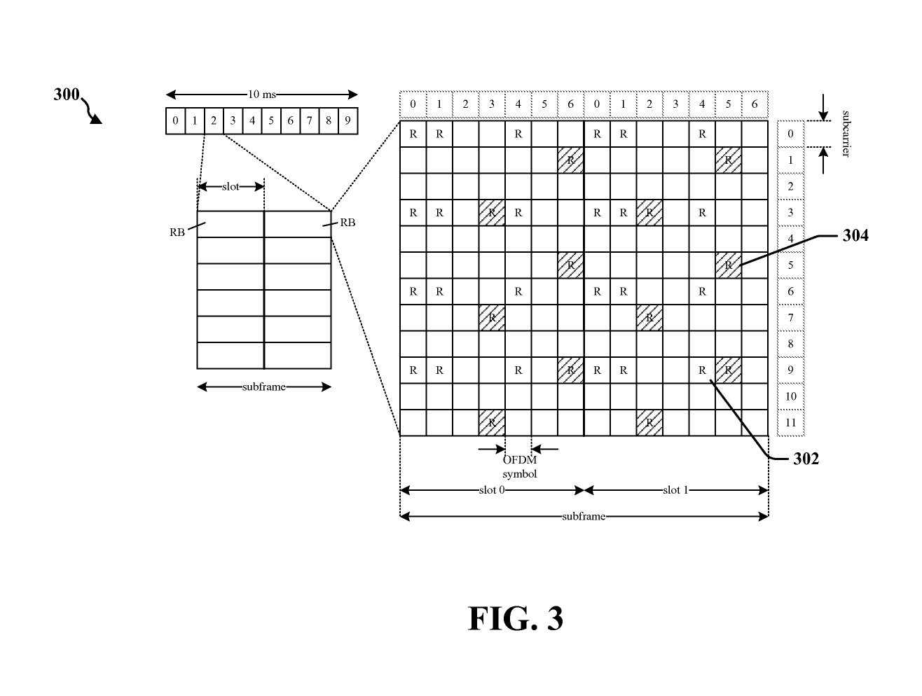

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

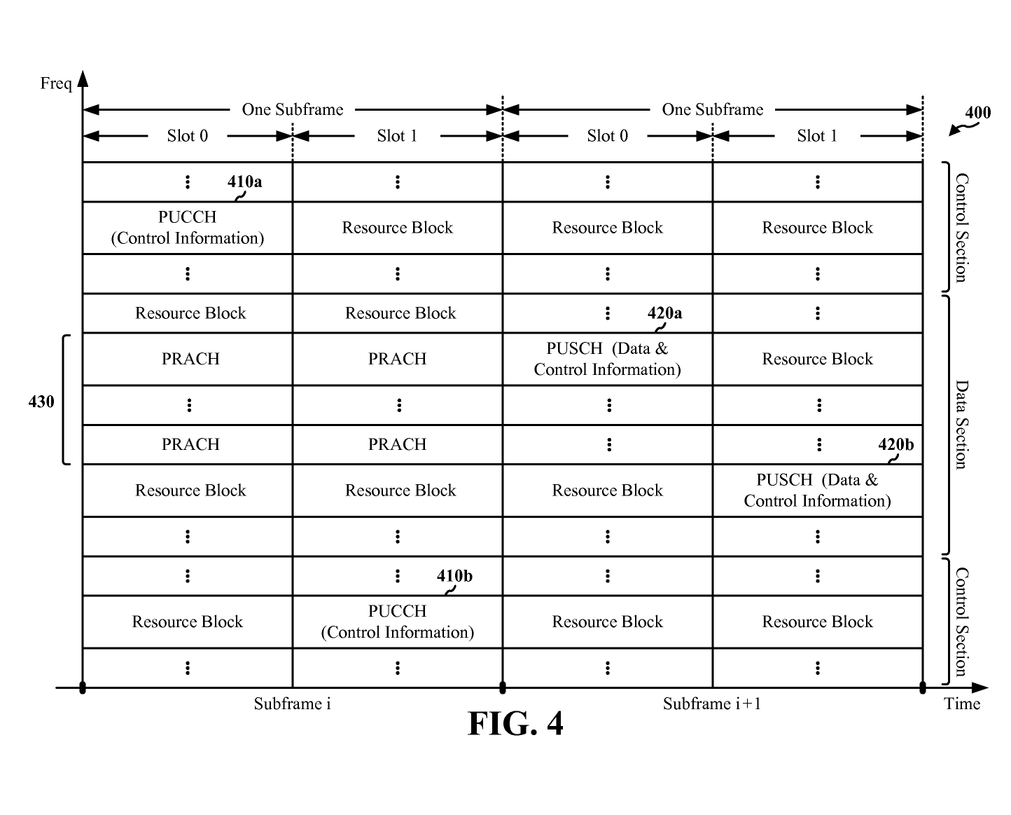

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

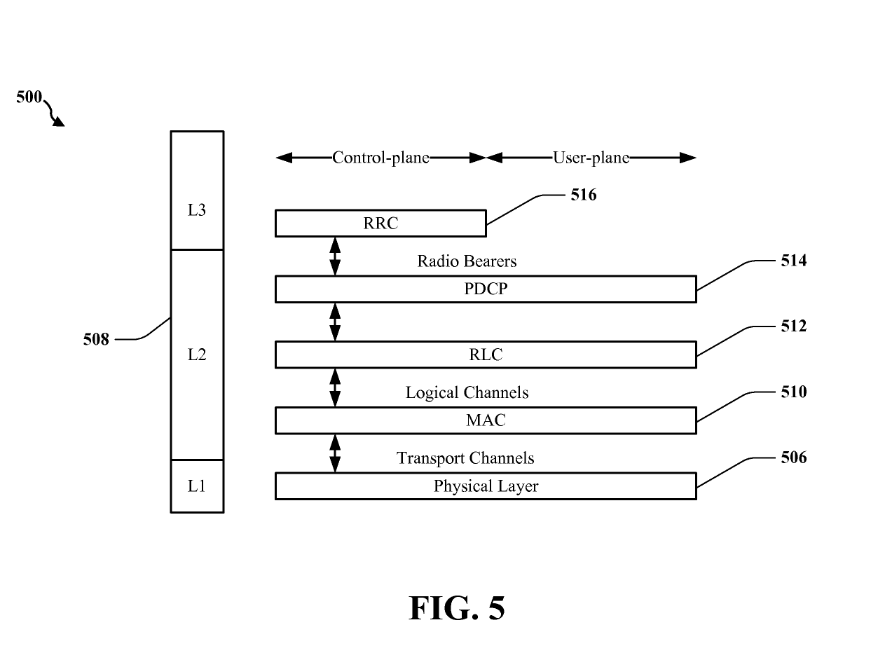

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

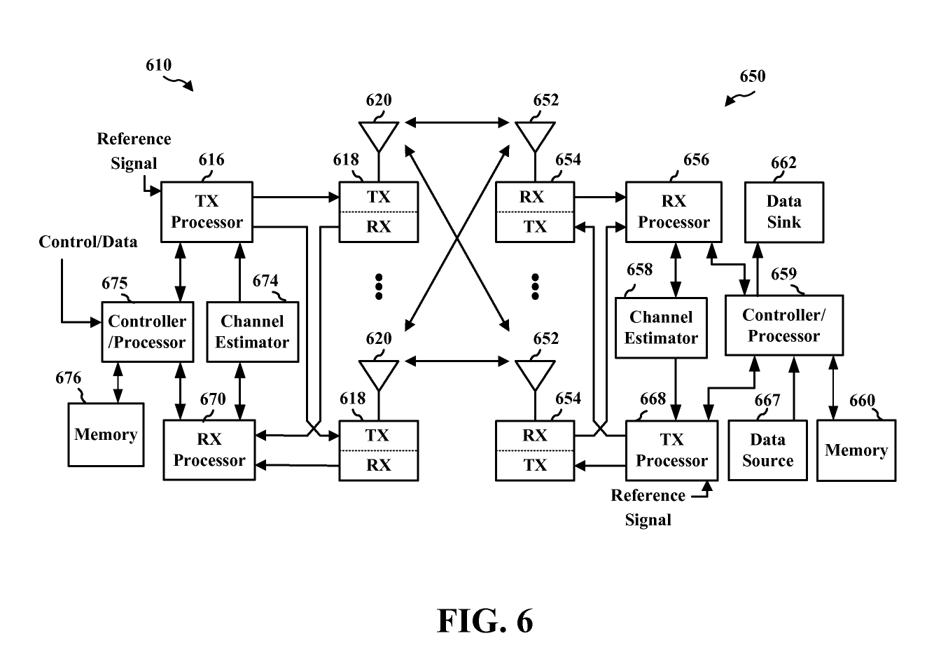

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

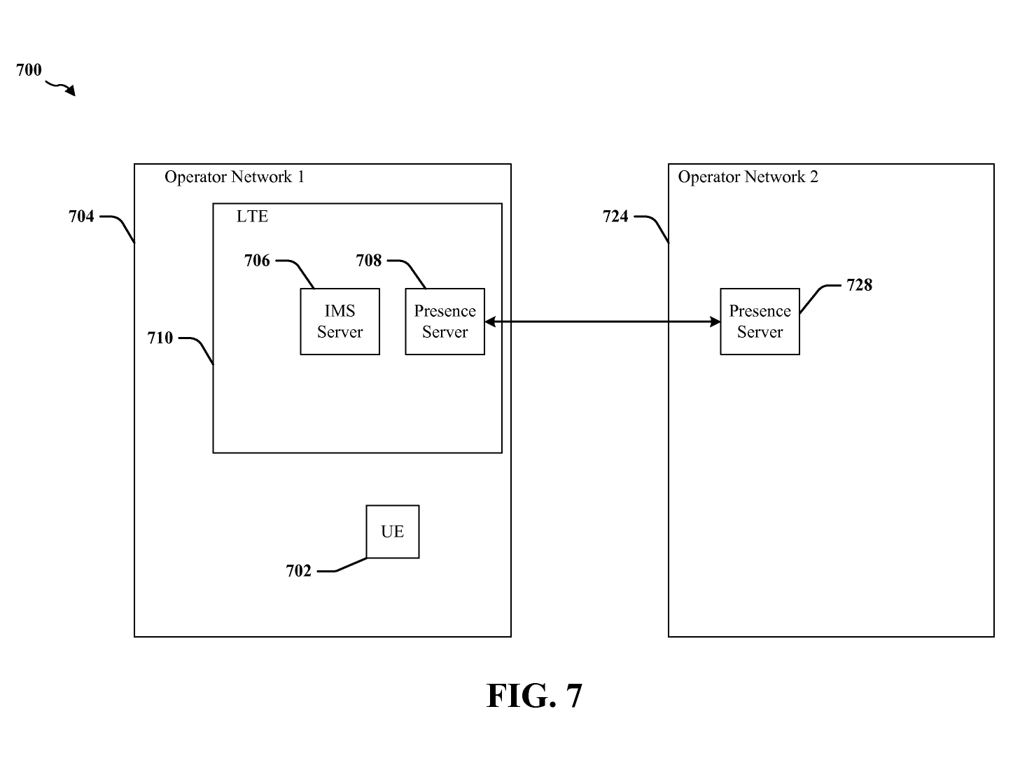

FIG. 7 is a diagram 700 that illustrates a networking environment in which two operators maintain networks 704 and 724. Each of operator networks 704 and 724 may support multiple radio access technologies (RATs) including, for example, LTE Radio Access Network (RAN) 710. Both networks 704 and 724 may provide access to a packet data network (PDN) and various services provided through the PDN. Networks 704 and 724 may be located in close geographic proximity and their respective coverage areas may overlap. In some embodiments, networks 704 and 724 may be may be physically remote from one another. Servers, gateways and other entities of network 704 may communicate with entities of network 724 using one or more backhaul connections such an X2 connection. In some embodiments, a common network such as the Internet may be used for communications between entities, devices and/or servers on networks 704 and 724.

In one example, network 704 comprises an LTE RAN 710 that provides access to an IMS server 706 and a presence server 708 maintained by network 704. IMS server 706 may provide UE 702 with access to mobile and fixed multimedia services. IMS server 706 delivers Internet-based services and may provide, for example, a voice-over-IP (VoIP) implementation using an adaptation of SIP to enable establishment of multimedia sessions between IMS users and/or users of the Internet.

UE 702 may access presence server 708 or be provided access to a presence server 728 on a different wireless network 724. UE 702 typically registers with a presence server 708 associated with the home network 704 of UE 704. In some embodiments, UE 702 may register with a different presence server 728 when, for example, the UE 702 is roaming on a network 724 other than the home network 704 of UE 702. Presence servers 708 and 728 may exchange information related to UE 702 and its connection status, and information related to other UEs that are presently connected, or have been connected, on networks 704 and 724. Presence server 708 may enable UE 702 to determine status of other equipment or users that are known to the presence server 708, including equipment and users identified by other presence servers 728. Status may include, for example, indications of location, availability to receive a call, busy on a call, connected, disconnected, active on the network and inactive but connected.

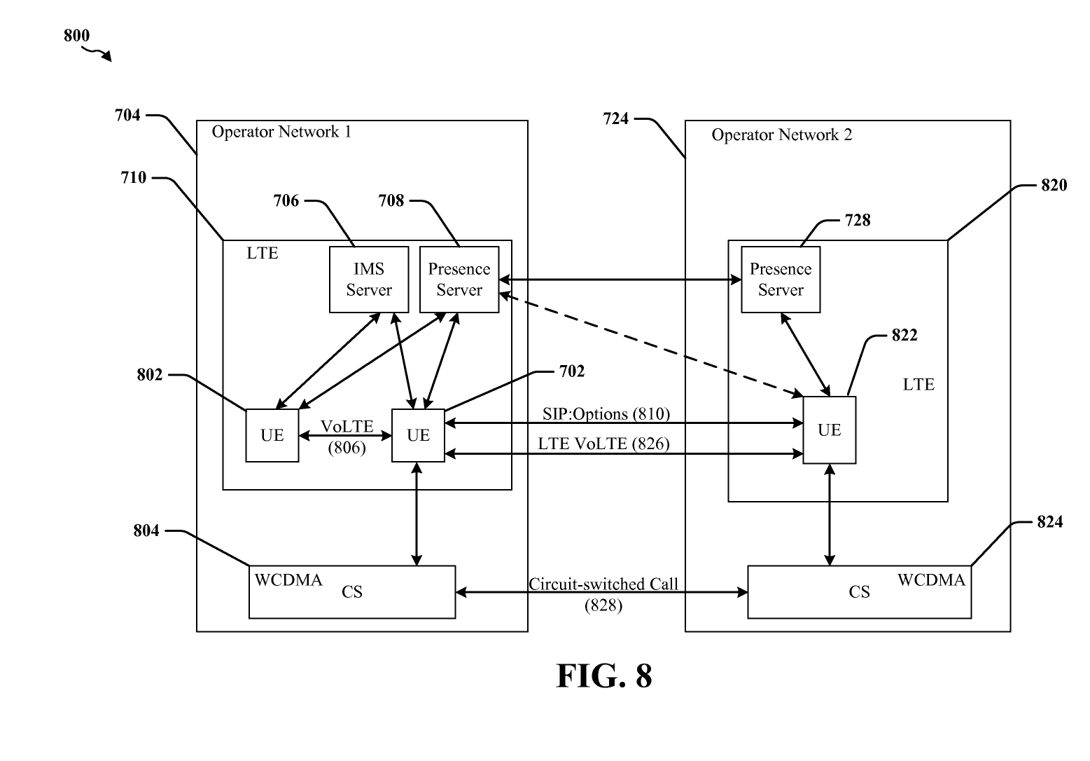

FIG. 8 is a diagram 800 illustrating interoperation of UEs 702, 802, 822, and network entities 706, 708, and 728. In certain embodiments, UE 702 determines characteristics of network 704 when a connection to the network 704 is established. The characteristics may define available RANs 710 and 804 and available services on RANs 710 and 804. For example, when connected to LTE RAN 710, UE 702 may determine that available services include one or more of VoLTE, video telephony and file sharing services. VoLTE may be designated by an operator of network 704 to be the preferred method of providing voice connections. The UE 702 may determine preferences, policies and/or permissions of an operator of the network 704 through signaling and configuration information. In one example, an operator of network 704 may support SVLTE using multiple antennas, but the operator may establish a preference that voice connections be made using a CS connection over a WCDMA RAN 804.

In some embodiments, UE 702 may register with an IMS server 706 for one or more voice, video telephony, and RCS services such as instant messaging and file sharing. UE 702 may then establish calls using VoLTE 806 and/or 826. Having registered with the IMS server 706, the UE 702 may announce its presence using a presence server 708. When IMS registration is not successfully completed, or if a receiving UE 802 or 822 is unavailable for VoLTE calls, the UE 702 may establish an automatic CS call (i.e., a dialed call) through WCDMA RAN 804, or another fallback RAN. VoLTE calls 806 and 826 may be established using an address book that identifies UEs 802 and/or 822 that have announced presence on presence server 708 or on another presence server 728 in communication with presence server 708. The address book may be maintained or enabled by presence server 708 or 728. When no presence server 708 or 728 is available, UE 702 may exchange information through SIP options 810 with UE 802 and/or UE 822 to determine mutual capabilities and to enable connections to be initiated.

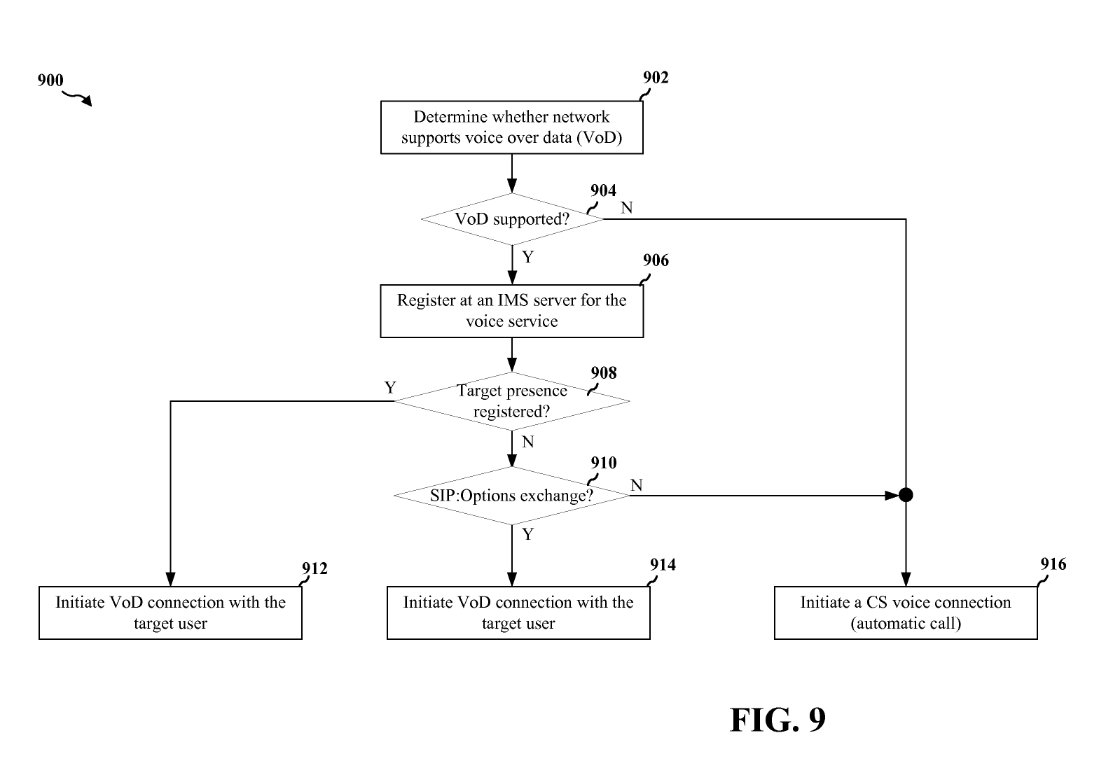

FIG. 9 is a flow chart 900 of a method of wireless communication. The method may be performed by UE 702 (and/or by UEs 802, 824). For the purposes of illustration, it will be assumed that UE 702 is connected and either active or camped on LTE RAN described in relation to the example in FIG. 9. The wireless data RAN may equally comprise a different data network, such as a WiFi network that supports VoIP voice services, an HSPA network, or other wireless RAN.

At step 902, UE 702 determines whether the wireless data RAN 710 supports a voice over data (VoD) service, such as VoLTE 806 and 826. The determination of voice capabilities may be based on configuration information provided and/or signaled by a network 704.

If at step 904, UE 702 determines that VoD service is not supported, then an automatic call may be initiated at step 916. The automatic call may be a CS voice connection over WCDMA RAN 804, for example. If VoD is determined to be supported, then UE 702 may additionally determine, at step 904, if VoD is available or permitted, based on operator preferences for example. If VoD is not permitted, the UE 702 may initiate an automatic CS call at step 916.

At step 906, UE 702 registers with IMS server 706 for the VoD service, having determined availability of the VoD service to the UE 702. The service may be deemed available when the wireless data RAN 710 supports the VoD service, and when an operator of the wireless data network permits use of the VoD service. Determination of the availability of services may be provided to UE 702 in a confirmation of registration received from the IMS server 706. Registering at the IMS server 706 may include registering UE 702 for video telephony service and/or a rich communication suite (RCS) service. The RCS service may comprise instant messaging. The RCS service may comprise a file sharing service.

At step 908, the UE 702 determines if a target UE 802 or 822 has announced its presence to a presence server 708 or 728 and is available to receive a call using the voice service. Presence information of the user may be maintained by presence server 708, presence server 728 or by one or more of a plurality of communicatively coupled presence servers that may include presence servers 708 and 728. Presence information may include a current status of a user and/or UE 802, or 822. Determining availability of the user to receive the voice call includes identifying the user in an address book maintained by one of a plurality of presence servers 708, 728. Determining the availability of the user may include determining from the presence information whether the user has access to a VoD service.

At step 910, the UE 702 may determine whether a user is available to receive the voice call using the VoD service by exchanging SIP options with UE 802 or 822 in order to determine mutual capabilities. In one example, SIP options 810 are exchanged when the target UE 802 or 822 has not announced its presence to a presence server 708 and 728. If at step 910, UE 702 determines that SIP options 810 have not, or cannot be exchanged, then UE 702 may initiate an automatic CS call at step 916. If SIP options 810 are exchanged and indicate that target UE 802 or 822 is available to receive such a call, then UE 702 initiates a VoD connection with target UE 802 or 822 at step 912. The VoD connection may be based on capabilities of the target UE 802 or 822 identified in the SIP options. Initiating the VoD connection may include establishing a voice call over one or more of an IP network, an HSPA network and an LTE network identified in the SIP options. Moreover, a CS voice connection may be established based on capabilities of the user identified in the SIP options.

If at step 908, the UE 702 determines that target UE 802 or 822 has announced its presence and availability to receive a VoD call, then at step 912, UE 702 initiates a VoD connection with the target UE 802 or 822.

In some embodiments, initiating a VoD connection may include initiating a video telephony call when the presence information of the user indicates that the user is capable of receiving video telephony calls.

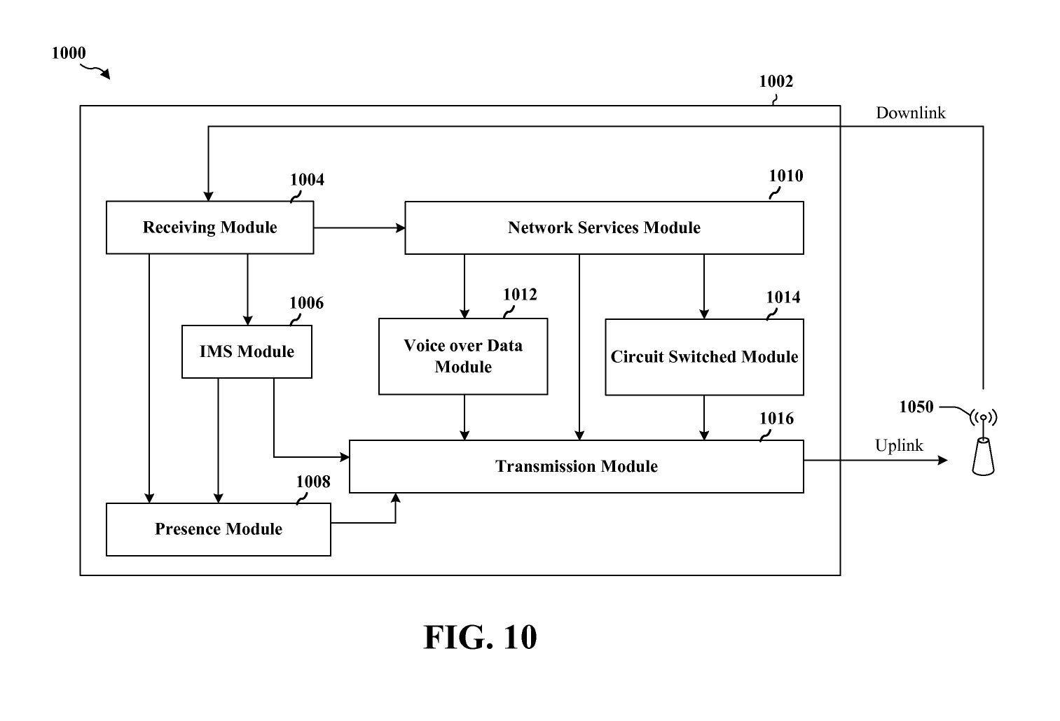

FIG. 10 is a conceptual data flow diagram 1000 illustrating the data flow between different modules/means/components in an exemplary apparatus 1002. The apparatus may be UE 702. The apparatus includes a receiving module 1004 that receives signaling, configuration information and messages from a wireless RAN, an IMS module 1006 that manages registration of the UE 702 with an IMS server 706, a presence module 1008 that announces and determines presence recorded by presence server 708 and/or 728, a network services module 1010 that manages establishment and use of network services on one or more RAN 710, 804, a VoD module 1012 that manages call establishment and termination over a data network such as LTE RAN 710, a CS module 1014 that manages CS call establishment and termination using, for example, a WCDMA RAN 804, and a transmission module 1016 that communicates with a network 704.

The apparatus may include additional modules that perform each of the steps of the algorithm in the aforementioned flow charts of FIG. 9. As such, each step in the aforementioned flow charts of FIG. 9 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

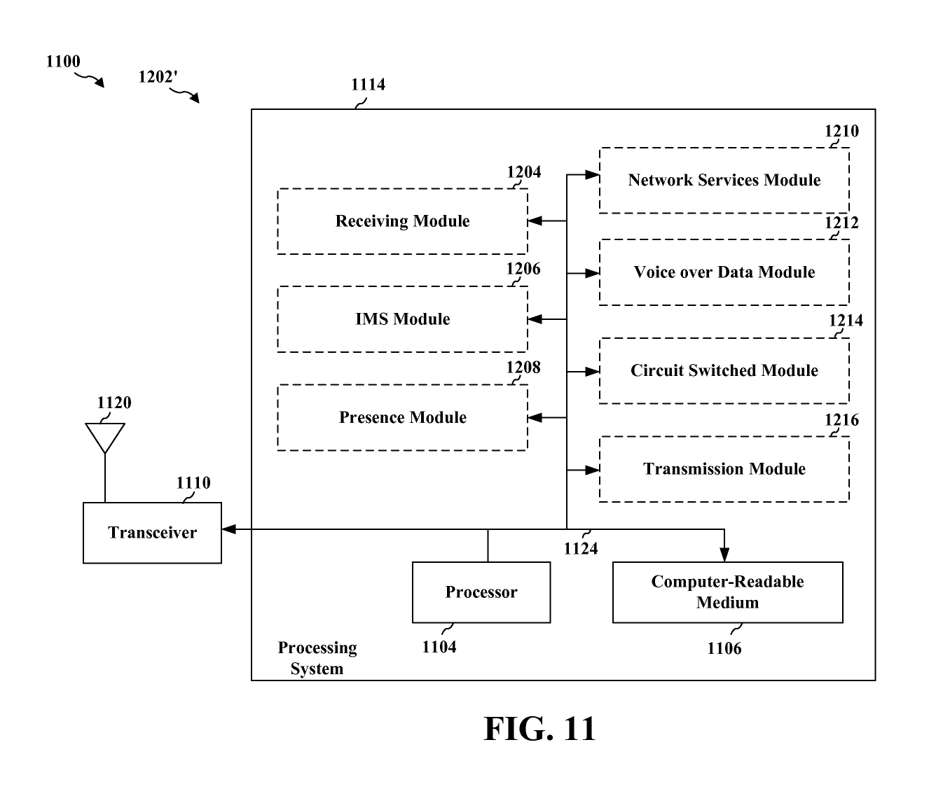

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware modules, represented by the processor 1104, the modules 1004, 1006, 1008, 1010, 1012, 1014, 1016, and the computer-readable medium 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The processing system 1114 includes a processor 1104 coupled to a computer-readable medium 1106. The processor 1104 is responsible for general processing, including the execution of software stored on the computer-readable medium 1106. The software, when executed by the processor 1104, causes the processing system 1114 to perform the various functions described supra for any particular apparatus. The computer-readable medium 1106 may also be used for storing data that is manipulated by the processor 1104 when executing software. The processing system further includes at least one of the modules 1004, 1006, 1008, 1010, 1012, 1014, and 1016. The modules may be software modules running in the processor 1104, resident/stored in the computer readable medium 1106, one or more hardware modules coupled to the processor 1104, or some combination thereof. The processing system 1114 may be a component of the UE 650 and may include the memory 660 and/or at least one of the TX processor 668, the RX processor 656, and the controller/processor 659.

In one configuration, the apparatus 1002/1002′ for wireless communication includes means 1004 for wirelessly receiving configuration information from a network entity, means 1010 for determining from the configuration information whether a wireless data network supports a voice service, means 1006 for registering at an IMS server 706 for the voice service, means 1008 for determining whether a target user is available to receive a voice call, means 1012 for initiating a VoD connection with the target user, means 1014 for initiating a CS voice connection when the user is determined to be unavailable to receive the VoD call, and means 1016 for transmitting over a wireless network. Means for receiving 1004 may be configured to receive confirmation of registration from the IMS server, and means 1008 may announce presence on a presence server after receiving the confirmation of registration at the IMS server.

The aforementioned means may be one or more of the aforementioned modules of the apparatus 1002 and/or the processing system 1114 of the apparatus 1002′ configured to perform the functions recited by the aforementioned means. As described supra, the processing system 1114 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of wireless communication, comprising:
determining from configuration information provided by a network entity whether a wireless data network supports a voice service;
registering at an internet protocol (IP) multimedia subsystem (IMS) server for the voice service when the wireless data network supports the voice service, and when an operator of the wireless data network permits use of the voice service;
determining whether a user is available to receive a voice call using the voice service based on presence information of the user;
initiating a voice over data connection with the user when the user is determined to be available to receive the voice call using the voice service; and
initiating a circuit-switched (CS) voice connection when the user is determined to be unavailable to receive the voice call using the voice service.

2. The method of claim 1, wherein the wireless data network comprises a WiFi network, and wherein the voice service comprises voice over IP (VoIP).

3. The method of claim 1, wherein the wireless data network comprises a high speed packet access (HSPA) network.

4. The method of claim 1, wherein the wireless data network comprises an LTE network.

5. The method of claim 4, wherein the voice service comprises voice over LTE (VoLTE).

6. The method of claim 1, further comprising:
receiving confirmation of registration from the IMS server; and
announcing presence on a presence server after receiving the confirmation of registration at the IMS server.

7. The method of claim 6, wherein the presence information of the user is maintained by the presence server.

8. The method of claim 6, wherein the presence information of the user is maintained by one of a plurality of communicatively coupled presence servers.

9. The method of claim 8, wherein the presence information of the user includes a current status of the user.

10. The method of claim 8, wherein determining availability of the user to receive the voice call includes identifying the user in an address book maintained by one of the plurality of presence servers.

11. The method of claim 8, wherein determining the availability of the user includes determining from the presence information whether the user has access to a voice over data service.

12. The method of claim 1, further comprising registering at the IMS server for video telephony service.

13. The method of claim 12, wherein initiating a voice over data connection includes initiating a video telephony call when the presence information of the user indicates that the user is capable of receiving video telephony calls.

14. The method of claim 1, further comprising registering at the IMS server for a rich communication suite (RCS) service.

15. The method of claim 14, wherein the RCS service includes instant messaging.

16. The method of claim 14, wherein the RCS service includes a file sharing service.

17. The method of claim 1, wherein determining whether a user is available to receive the voice call using the voice service includes exchanging session initiation protocol (SIP) options with the user.

18. The method of claim 17, further comprising initiating the voice over data connection with the user based on capabilities of the user identified in the SIP options.

19. The method of claim 18, wherein initiating the voice over data connection with the user includes establishing a voice call over one or more of an IP network, an HSPA network and an LTE network identified in the SIP options.

20. The method of claim 17, further comprising initiating the CS voice connection based on capabilities of the user identified in the SIP options.

21. An apparatus for wireless communication, comprising:
means for determining from configuration information provided by a network entity whether a wireless data network supports a voice service;
means for registering at an internet protocol (IP) multimedia subsystem (IMS) server for the voice service when the wireless data network supports the voice service, and when an operator of the wireless data network permits use of the voice service;
means for determining whether a user is available to receive a voice call using the voice service based on presence information of the user;
means for initiating a voice over data connection with the user when the user is determined to be available to receive the voice call using the voice service; and
means for initiating a circuit-switched (CS) voice connection when the user is determined to be unavailable to receive the voice call using the voice service.

22. The apparatus of claim 21, wherein the wireless data network comprises a WiFi network, and wherein the voice service comprises voice over IP (VoIP).

23. The apparatus of claim 21, wherein the wireless data network comprises a high speed packet access (HSPA) network.

24. The apparatus of claim 21, wherein the wireless data network comprises an LTE network.

25. The apparatus of claim 24, wherein the voice service comprises voice over LTE (VoLTE).

26. The apparatus of claim 21, further comprising:
means for receiving confirmation of registration from the IMS server; and
means for announcing presence on a presence server after receiving the confirmation of registration at the IMS server.

27. The apparatus of claim 26, wherein the presence information of the user is maintained by the presence server.

28. The apparatus of claim 26, wherein the presence information of the user is maintained by one of a plurality of communicatively coupled presence servers.

29. The apparatus of claim 28, wherein the presence information of the user includes a current status of the user.

30. The apparatus of claim 28, wherein determining availability of the user to receive the voice call includes identifying the user in an address book maintained by one of the plurality of presence servers.

31. The apparatus of claim 28, wherein determining the availability of the user includes determining from the presence information whether the user has access to a voice over data service.

32. The apparatus of claim 21, further comprising registering at the IMS server for video telephony service.

33. The apparatus of claim 32, wherein initiating a voice over data connection includes initiating a video telephony call when the presence information of the user indicates that the user is capable of receiving video telephony calls.

34. The apparatus of claim 21, further comprising registering at the IMS server for a rich communication suite (RCS) service.

35. The apparatus of claim 34, wherein the RCS service includes instant messaging.

36. The apparatus of claim 34, wherein the RCS service includes a file sharing service.

37. The apparatus of claim 21, wherein determining whether a user is available to receive the voice call using the voice service includes exchanging session initiation protocol (SIP) options with the user.

38. The apparatus of claim 37, wherein the means for initiating the voice over data connection initiates the voice over data connection with the user based on capabilities of the user identified in the SIP options.

39. The apparatus of claim 38, wherein the means for initiating the voice over data connection with the user establishes a voice call over one or more of an IP network, an HSPA network and an LTE network identified in the SIP options.

40. The apparatus of claim 37, wherein the means for initiating the CS voice connection initiates the CS voice connection based on capabilities of the user identified in the SIP options.

41. An apparatus for wireless communication, comprising:
a processing system configured to:
determine from configuration information provided by a network entity whether a wireless data network supports a voice service;
register at an internet protocol (IP) multimedia subsystem (IMS) server for the voice service when the wireless data network supports the voice service, and when an operator of the wireless data network permits use of the voice service;
determining whether a user is available to receive a voice call using the voice service based on presence information of the user;
initiate a voice over data connection with the user when the user is determined to be available to receive the voice call using the voice service; and
initiate a circuit-switched (CS) voice connection when the user is determined to be unavailable to receive the voice call using the voice service.

42. The apparatus of claim 41, wherein the wireless data network comprises a WiFi network, and wherein the voice service comprises voice over IP (VoIP).

43. The apparatus of claim 41, wherein the wireless data network comprises a high speed packet access (HSPA) network.

44. The apparatus of claim 41, wherein the wireless data network comprises an LTE network.

45. The apparatus of claim 44, wherein the voice service comprises voice over LTE (VoLTE).

46. The apparatus of claim 41, wherein the processing system is further configured to:
receive confirmation of registration from the IMS server; and
announce presence on a presence server after receiving the confirmation of registration at the IMS server.

47. The apparatus of claim 46, wherein the presence information of the user is maintained by the presence server.

48. The apparatus of claim 46, wherein the presence information of the user is maintained by one of a plurality of communicatively coupled presence servers.

49. The apparatus of claim 48, wherein the presence information of the user includes a current status of the user.

50. The apparatus of claim 48, wherein determining availability of the user to receive the voice call includes identifying the user in an address book maintained by one of the plurality of presence servers.

51. The apparatus of claim 48, wherein determining the availability of the user includes determining from the presence information whether the user has access to a voice over data service.

52. The apparatus of claim 41, wherein the processing system is further configured to register at the IMS server for video telephony service.

53. The apparatus of claim 52, wherein a voice over data connection is initiated by initiating a video telephony call when the presence information of the user indicates that the user is capable of receiving video telephony calls.

54. The apparatus of claim 41, wherein the processing system is further configured to register at the IMS server for a rich communication suite (RCS) service.

55. The apparatus of claim 54, wherein the RCS service includes instant messaging.

56. The apparatus of claim 54, wherein the RCS service includes a file sharing service.

57. The apparatus of claim 41, wherein availability of the user to receive the voice call using the voice service is determined by exchanging session initiation protocol (SIP) options with the user.

58. The apparatus of claim 57, wherein the processing system is further configured to initiate the voice over data connection with the user based on capabilities of the user identified in the SIP options.

59. The apparatus of claim 58, wherein the voice over data connection with the user is initiated by establishing a voice call over one or more of an IP network, an HSPA network and an LTE network identified in the SIP options.

60. The apparatus of claim 57, wherein the processing system is further configured to initiate the CS voice connection based on capabilities of the user identified in the SIP options.

61. A computer program product, comprising:
a computer-readable medium comprising code for:
determining from configuration information provided by a network entity whether a wireless data network supports a voice service;
registering at an internet protocol (IP) multimedia subsystem (IMS) server for the voice service when the wireless data network supports the voice service, and when an operator of the wireless data network permits use of the voice service;
determining whether a user is available to receive a voice call using the voice service based on presence information of the user;
initiating a voice over data connection with the user when the user is determined to be available to receive the voice call using the voice service; and
initiating a circuit-switched (CS) voice connection when the user is determined to be unavailable to receive the voice call using the voice service.
